(19) United States
(12) Patent Application Publication
(10) Pub. No.: US 2019/0022847 A1
(43) Pub. Date: Jan. 24, 2019

(54) MULTI-FUNCTION TOOL

(71) Applicant: Dean A. Weathers, Medford, OR (US)

(72) Inventor: Dean A. Weathers, Medford, OR (US)

(21) Appl. No.: 15/655,074

(22) Filed: Jul. 20, 2017

(51) Int. Cl. B25F 1/00; B25B 13/48; B25B 13/06; B25B 23/16

(52) U.S. Cl. CPC B25F 1/003; B25B 23/16; B25B 13/06; B25B 13/48

(57) ABSTRACT

A multi-function tool has a body defining a plurality of tool facilities, a selected one of the tool facilities being an aperture adapted to receive a loop element, the aperture including a first portion defining a tool interface adapted to operably receive a device having a selected peripheral profile, and the aperture having a second portion defining a lobe extending beyond the peripheral profile. The tool interface may have opposed parallel sides adapted to function as a wrench. The tool interface may be a portion of a hexagon. The tool interface may be adapted to closely receive a ¼ inch hex shank. The tool interface may be adapted to closely receive a hexagonal element. The tool interface may be polygonal. The body may be a unitary planar element having opposed major faces. The body may be a sheet metal element with a uniform thickness.

### FIELD OF THE INVENTION

The present invention relates to multi-function tools, and more particularly to a multi-function tool that enables the key ring aperture to be used as a wrench without removing the key ring.

### BACKGROUND OF THE INVENTION

Multi-function tools are hand tools that combine multiple individual functions into a single element. The most portable types are designed to be carried on a key ring, typically by including an aperture that receives the key ring.

U.S. Pat. No. 7,856,917 to Noveske discloses a Switchblock® manufactured by Noveske Rifleworks LLC of Grants Pass, Oreg. The Switchblock® is an adjustable gas block designed to improve function and reliability when using a suppressor with a gas-operated rifle. The gas block has three gas settings: unsuppressed, suppressed, and off. The setting is easily changed by depressing a locking plunger and rotating an adjustment knob to the desired setting. Some users find it helpful to use a specially adapted Switchblock® wrench that fits the profile of the adjustment knob to turn the adjustment knob in the event the mechanism becomes stiff to turn. Although the prior art specialized wrench is functional and compact, it omits an aperture for attaching to a key ring, and the only other function included is a feature to remove bottle caps.

Therefore, a need exists for a new and improved multi-function tool that can be attached to a key ring and enables the key ring aperture to be used as a wrench without removing the key ring. In this regard, the various embodiments of the present invention substantially fulfill at least some of these needs. In this respect, the multi-function tool according to the present invention substantially departs from the conventional concepts and designs of the prior art, and in doing so provides an apparatus primarily developed for the purpose of providing a multi-function tool that can be attached to a key ring and enables the key ring aperture to be used as a wrench without removing the key ring.

### SUMMARY OF THE INVENTION

The present invention provides an improved multi-function tool, and overcomes the above-mentioned disadvantages and drawbacks of the prior art. As such, the general purpose of the present invention, which will be described subsequently in greater detail, is to provide an improved multi-function tool that has all the advantages of the prior art mentioned above.

To attain this, the preferred embodiment of the present invention essentially comprises a body defining a plurality of tool facilities, a selected one of the tool facilities being an aperture adapted to receive a loop element, the aperture including a first portion defining a tool interface adapted to operably receive a device having a selected peripheral profile, and the aperture having a second portion defining a lobe extending beyond the peripheral profile. The tool interface may have opposed parallel sides adapted to function as a wrench. The tool interface may be a portion of a hexagon. The tool interface may be adapted to closely receive a ¼ inch hex shank. The tool interface may be adapted to closely receive a hexagonal element. The tool interface may be polygonal. The body may be a unitary planar element having opposed major faces. The body may be a sheet metal element with a uniform thickness. There are, of course, additional features of the invention that will be described hereinafter and which will form the subject matter of the claims attached.

There has thus been outlined, rather broadly, the more important features of the invention in order that the detailed description thereof that follows may be better understood and in order that the present contribution to the art may be better appreciated.

### BRIEF DESCRIPTION OF THE DRAWINGS

FIG. 1 is a top view of the current embodiment of a multi-function tool constructed in accordance with the principles of the present invention.

FIG. 2 is an isometric view of the current embodiment of the multi-function tool of FIG. 1 in use as a wrench.

The same reference numerals refer to the same parts throughout the various figures.

### DESCRIPTION OF THE CURRENT EMBODIMENT

An embodiment of the multi-function tool of the present invention is shown and generally designated by the reference numeral 10.

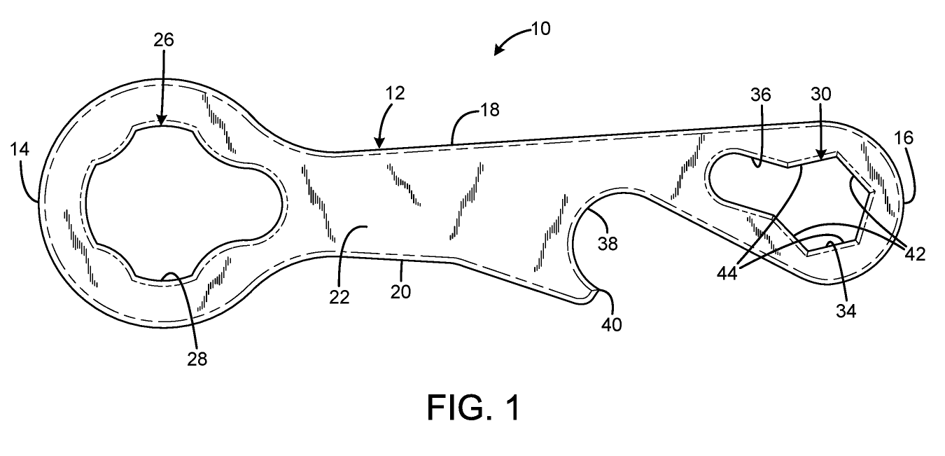

FIG. 1 illustrates the improved multi-function tool 10 of the present invention. More particularly, the multi-function tool is a body 12 having a front 14, rear 16, right side 18, left side 20, top 22, and bottom 24. In the current embodiment, the body is a unitary planar element having opposed major faces (the top and the bottom), and is a sheet metal element having a uniform thickness of 3/16 inch. The front of the body is rounded and enlarged to define a front tool facility 26. In the current embodiment, the front tool facility is an aperture 28 having a profile that is adapted to closely receive the adjustment knob (not shown) disclosed in U.S. Pat. No. 7,856,917 to Noveske, which is hereby incorporated by reference for all that is taught therein. This aperture may be sized and adapted for any other use or application without departing from the invention, and there may be any number of such apertures and features for various purposes as may be desired.

The rear of the body is rounded, but not enlarged, to define a rear tool facility 30. In the current embodiment, the rear tool facility is an aperture 32 including a first portion that defines a tool interface 34 and a second portion that defines a lobe 36. The aperture 32 is a standard ¼″ hex drive shape that closely receives common screwdriver bits as are used with most battery-powered screwdrivers and drills. The tool interface has opposed parallel sides 42, 44 adapted to function as a wrench, and is a portion of a hexagon in the current embodiment. In the current embodiment, the tool interface includes five sides of a hexagon, and the lobe extends outward in place of what would otherwise be the sixth side of a hexagon. In alternative embodiments, any number of the sides of the hexagon may be present, including as few as the parallel sides 42, 44. The left side of the body defines a curved recess 38 and hook portion 40 that together serve as a feature for removing bottle caps from bottles. The aperture may be any polygon or shape that receives a bit, tool, or fastener in order to apply torque to it, and the lobe portion 36 of the aperture that extends beyond the periphery of what is needed to provide the torque function so that the lobe remains open even when a bit, tool, or fastener occupies the tool interface portion 34.

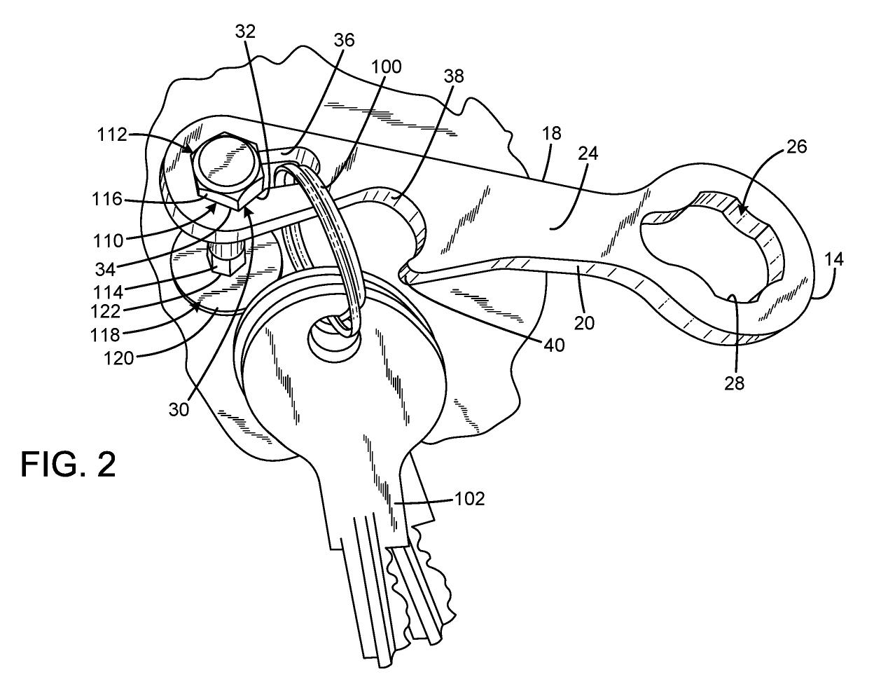

FIG. 2 illustrates the improved multi-function tool 10 of the present invention. More particularly, the multi-function tool is shown in use as a wrench to turn a fastener 118. The tool interface 34 is adapted to operably receive a device having a selected peripheral profile. In FIG. 2, the device/element is a bit 110 having a shank 112 and a tip 114. The shank has a peripheral profile 116, which is a ¼ inch hexagon in the current embodiment. The tool interface is adapted to closely receive the hexagonal element, where closely receive means receiving of the element to prevent rotation and enable the application of torque to a bit, nut, bolt head, or the like. The tip is adapted to be closely received by a socket 122 in the head 120 of a fastener 118. As a result, the body can be used as a wrench to apply torque to the bit to rotate the fastener.

The aperture 32 also enables the body 12 to be attached to a key ring/loop element 100 having keys 102. The lobe portion 36 of the aperture enables the key ring to be moved out of the tool interface portion 34 to leave the tool interface unobstructed. Thus, the tool interface can receive the shank 112 of the hexagonal bit 110 without requiring removal of the key ring from the body. This novel feature greatly increases the ease of use of the present invention. The aperture 26 is also not obstructed when the body is attached to a key ring, so the front tool facility 24 is always available to closely receive the adjustment knob (not shown) disclosed in U.S. Pat. No. 7,856,917 to Noveske so the body can be used to apply torque to rotate the adjustment knob. Besides a key ring, the principle of the invention can be used to attach a tether, lanyard, or sling, or another tool. In the current embodiment, the key ring is a member having a diameter of at least ½″.

While a current embodiment of a multi-function tool has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A multi-function tool comprising:
a body defining a plurality of tool facilities;
a selected one of the tool facilities being an aperture adapted to receive a loop element;
the aperture including a first portion defining a tool interface adapted to operably receive a device having a selected peripheral profile; and
the aperture having a second portion defining a lobe extending beyond the peripheral profile.

2. The multi-function tool of claim 1 wherein the tool interface has opposed parallel sides adapted to function as a wrench.

3. The multi-function tool of claim 1 wherein the tool interface is a portion of a hexagon.

4. The multi-function tool of claim 1 wherein the tool interface is adapted to closely receive a ¼ inch hex shank.

5. The multi-function tool of claim 1 wherein the tool interface is adapted to closely receive a hexagonal element.

6. The multi-function tool of claim 1 wherein the tool interface is polygonal.

7. The multi-function tool of claim 1 wherein the body is a unitary planar element having opposed major faces.

8. The multi-function tool of claim 1 wherein the body is a sheet metal element with a uniform thickness.

9. The multi-function tool of claim 1 wherein the lobe extends eccentrically in one direction away from the profile.

10. The multi-function tool of claim 1 wherein the lobe defines a passage outside of the profile adapted to receive a member having a diameter of at least ½″.
